(19) United States
(12) Patent Application Publication
(10) Pub. No.: US 2011/0266845 A1
(43) Pub. Date: Nov. 3, 2011

(54) SEATING APPARATUS FOR USE ON A VEHICLE HAVING A FLAT CARRYING AREA

(76) Inventors: Neal Marshall, West Midlands (GB); Brian Richard Hallett, Essex (GB)

(21) Appl. No.: 13/138,078

(22) PCT Filed: Jan. 5, 2010
(86) PCT No.: PCT/GB2010/000006

§ 371 Date: Jul. 1, 2011

(30) Foreign Application Priority Data
Jan. 5, 2009 (GB) 0900105.8

(51) Int. Cl. B60N 2/42; B60N 2/01; B60R 21/13

(52) U.S. Cl. 297/216.1

(57) ABSTRACT

Seating apparatus (2) for use on a vehicle (4) having a flat carrying area (6), which seating apparatus (2) comprises a frame giving roll over protection to a person (10) seated on the seating apparatus (2) in the event that the vehicle (4) should roll over onto its side, at least one side facing seat (12) which is mounted in the frame (8) and on which the person (10) sits, and securing means (14) for releasably securing the seating apparatus (2) on the flat carrying area (6) of the vehicle (4) whereby the seating apparatus (2) is able to be secured on the flat carrying area (6) and removed from the flat carrying area (6), characterised in that the frame (8) includes at least one protection bar (16) which extends longitudinally with respect to the vehicle (4), which is positioned at an angle with respect to a vertical plane (18) extending longitudinally through the frame (8), and which is positioned at an upper part (20) of the frame (8), whereby the protection bar (16) affords protection to the person (10) on the seat (12) in the event of an object falling onto the seating apparatus (2) from above and whilst the vehicle (4) is travelling normally.

This invention relates to seating apparatus and, more especially, this invention relates to seating apparatus for use on a vehicle having a flat carrying area. This invention also relates to the vehicle when provided with the seating apparatus.

Vehicles for carrying cargo are often in the form of a truck having a driving cab and a back which forms a storage area. The back of the vehicle can be a flat back or it can be canvas-covered with drop down sides and a tail gate. There is generally no structural protection for the storage area. The storage area may be for carrying cargo and/or persons. If the storage area is to carry persons, then the persons may be military personnel. In order to carry the persons, it is known to install bench-type seating with specific securing means securing the bench-type seating to the back of the vehicle. The vehicle may be an armoured military vehicle for carrying military personnel on the bench-type seating. Irrespective of the type of vehicle, in the event that the vehicle is involved in an accident, persons sitting on the bench-type seating are often thrown about and they invariably suffer injury or death. The problem is especially acute if the vehicle is involved in an accident which causes the vehicle to roll over on its side.

International Patent Publication Nos. WO 2005/002916 and WO 2006/005965 obviate or reduce the above mentioned problem by providing seating apparatus which comprises a frame which gives side roller over protection to persons on side facing seats of the seating apparatus.

The frames disclosed in WO 2005/002916 and WO 2006/005965 do not provide as much protection as is desired in the event of an object falling onto the seating apparatus from above and whilst the vehicle is travelling normally. It is an aim of the present invention to obviate or reduce this problem.

Accordingly, in one non-limiting embodiment of the present invention there is provided seating apparatus for use on a vehicle having a flat carrying area, which seating apparatus comprises a frame giving roll over protection to a person seated on the seating apparatus in the event that the vehicle should roll over onto its side, at least one side facing seat which is mounted in the frame and on which the person sits, and securing means for releasably securing the seating apparatus on the flat carrying area of the vehicle whereby the seating apparatus is able to be secured on the flat carrying area and removed from the flat carrying area, characterised in that the frame includes at least one protection bar which extends longitudinally with respect to the vehicle, which is positioned at an angle with respect to a vertical plane extending longitudinally through the frame, and which is positioned at an upper part of the frame, whereby the protection bar affords protection to the person on the seat in the event of an object falling onto the seating apparatus from above and whilst the vehicle is travelling normally.

The protection bar is especially advantageous if the vehicle is travelling through wooded areas where branches or tree trunks may fall or topple onto the vehicle. The branches or tree trunks may topple as a result of being rendered unsafe due to age or previous military or other activity in the area. The use of the securing means enables the seating apparatus to be deployed as and when necessary. When the seating apparatus is not required, then the vehicle is available for carrying other types of cargo such for example as goods in packaged containers.

The seating apparatus may be one in which there is a plurality of the side facing seats, with at least a first one of the seats facing a first side of the vehicle and at least a second one of the seats facing a second side of the vehicle, and in which there are two of the protection bars, with a first one of the protection bars being for a first one of the seats facing the first side of the vehicle, and with a second one of the protection bars being for the second one of the seats facing the second side of the vehicle.

Usually, the plurality of seats will be arranged in two rows with the first row facing the first side of the vehicle and the second row facing the second side of the vehicle. Usually there will be a plurality of seats in each row. Thus, for example, there may be ten or twelve of the seats in each row.

The or each protection bar will usually be integrally formed with the remainder of the frame. Thus the or each protection bar may be welded to the remainder of the frame.

The or each protection bar may make an angle of 5-25° with the vertical plane. The or each protection bar may make an angle of 20° with the vertical plane.

The or each protection bar may be at a height which enables easy access to the seat for getting on and off the seat.

The present invention also provides a vehicle when provided with the seating apparatus.

An embodiment of the invention will now be described solely by way of example and with reference to the accompanying drawings in which:

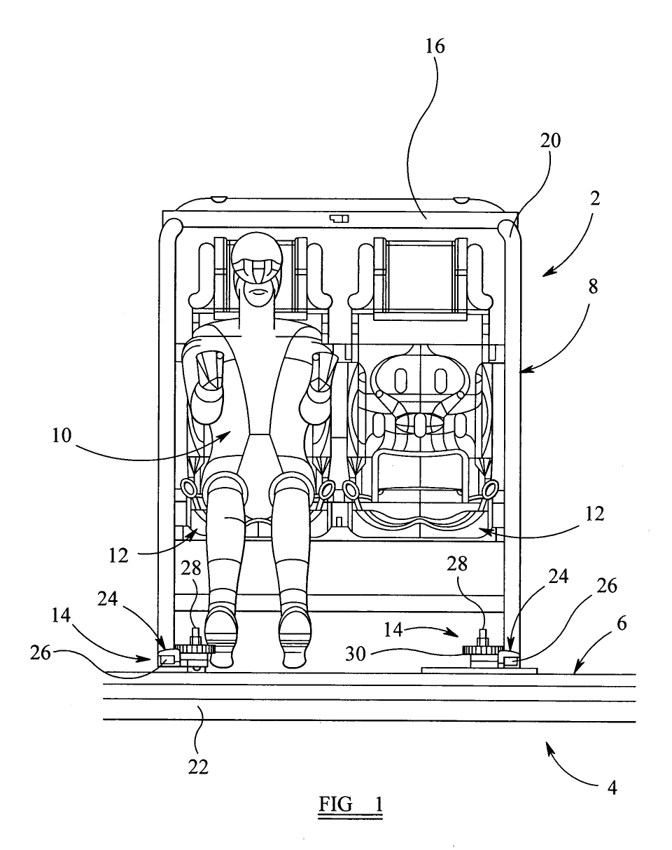

FIG. 1 is a view from one side of seating apparatus on a vehicle having a flat carrying area; and

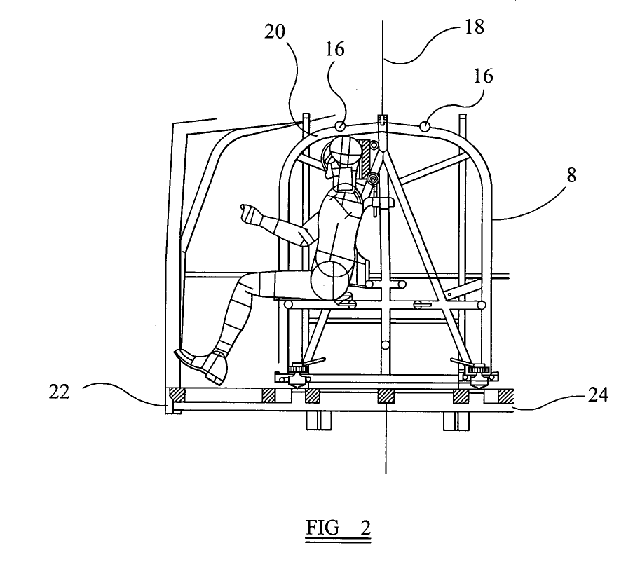

FIG. 2 is an end view of the seating apparatus shown in FIG. 1.

Referring to the drawings, there is shown seating apparatus 2 for use on a vehicle 4 having a flat carrying area 6. For simplicity of illustration, the vehicle 4 has not been shown in detail but it comprises a driving cab at a front end of the flat carrying area 6.

The seating apparatus 2 comprises a frame 8 giving roll over protection to a person 10 seated on the seating apparatus 2 in the event that the vehicle 4 should roll over onto its side. The seating apparatus 2 also comprises at least one side facing seat 12 which is mounted in the frame 8 and on which the person 10 sits. The seating apparatus 2 further comprises securing means 14 for releasably securing the seating apparatus 2 on the flat carrying area 6 of the vehicle 4, whereby the seating apparatus is able to be secured on the flat carrying area 6 and removed from the flat carrying area 6.

The frame 8 includes at least one protection bar 16. The protection bar 16 extends longitudinally with respect to the vehicle 4. As can best be appreciated from FIG. 2, the protection bar 16 is positioned at an angle with respect to a vertical plane 18 extending longitudinally through the frame 8. The protection bar 16 is positioned at an upper part 20 of the frame 8. The protection bar 16 affords protection to the person 10 on the seat 12 in the event of an object (not shown) falling onto the seating apparatus 2 from above and whilst the vehicle 4 is travelling normally. As shown in FIG. 1, the normal direction of travel of the vehicle 4 would be to the left.

The seating apparatus 2 is such that there is a plurality of the side facing seats 12. More specifically, there are two of the seats 12 facing a first side 22 of the vehicle 4 as can be appreciated from FIGS. 1 and 2. There are also two of the seats 4 facing a second side 24 of the vehicle 4. These seats 12 facing the second side 24 of the vehicle 2 are not shown in FIG. 2 and this is to illustrate the fact that the seats 12 are demountable from the remainder of the frame 8 in order to reduce the weight of the frame 8 during installation. Once the frame 8 has been installed on the flat carrying area 6, the seats 12 can be installed. Alternatively, if desired, the seats 12 can be permanently secured to the frame 8.

As shown in FIG. 2, there are two of the protection bars 16. A first one of the protection bars 16 is for the two seats 12 facing the first side 22 of the vehicle 4. The second one of the protection bars 16 is for the seats 12 facing the second side 24 of the vehicle 4.

As can be appreciated from FIG. 1, the seats 12 on either side 22, 24 of the vehicle 4 are arranged in two rows, with the first row facing the first side 22 of the vehicle 4, and the second row facing the second side 24 of the vehicle 4.

The protection bars 16 are integrally formed by welding with the remainder of the frame 8. Each protection bar 16 makes an angle of approximately 20° with the vertical plane 18. Each protection bar 16 is at a height which enables easy access by the person 10 to the seat 12 for getting on and off the seat 12.

Apart from the provision of the protection bars 16, the frame 8 may be constructed as shown in WO 2005/002916 and WO 2006/005965.

The securing means 14 may comprise a forked arrangement 24 which rests on top of a frame member 26. The securing means 14 may also comprise a handle 28 which, when moved through 90°, moves a spigot in relation to an elongated hole, for example a star shaped hole or an elliptical hole. This causes the securing means 14 to secure in a two-dimensional manner. A hand wheel 30 is then able to be rotated to tighten and secure the forked arrangement 24 on top of the frame member 26 in a vertical direction. Alternatively, if desired, the securing means 14 may be as disclosed in WO 2005/002916 and WO 2006/005965.

The seats 12 may be as shown in the drawings. Alternatively, the seats 12 may be as shown in WO 2006/040516. Thus the seats 12 may each be such that they comprise a seat portion having a concave recess for receiving the buttocks of the person 10, with the seat portion being made of a hard material which does not compress when sat upon by the person 10, and with the concave recess comprising two depressions connected together by a central neck part, and with the concave recess extending into a first concave passage portion for receiving a rear thigh part of a first leg of the person 10, and into a second concave passage portion for receiving a rear thigh part of a second leg of the person 10.

It is to be appreciated that the embodiment of the invention described above with reference to the accompanying drawings has been given by way of example only and that modifications, for example those mentioned above, may be effected. Individual components shown in the drawings are not limited to use in their drawings and they may be used in other drawings and in all aspects of the invention.

1. Seating apparatus for use on a vehicle having a flat carrying area, which seating apparatus comprises a frame giving roll over protection to a person seated on the seating apparatus in the event that the vehicle should roll over onto its side, at least one side facing seat which is mounted in the frame and on which the person sits, and securing means for releasably securing the seating apparatus on the flat carrying area of the vehicle whereby the seating apparatus is able to be secured on the flat carrying area and removed from the flat carrying area, characterised in that the frame includes at least one protection bar which extends longitudinally with respect to the vehicle, which is positioned at an angle with respect to a vertical plane extending longitudinally through the frame, and which is positioned at an upper part of the frame, whereby the protection bar affords protection to the person on the seat in the event of an object falling onto the seating apparatus from above and whilst the vehicle is travelling normally.

2. Seating apparatus according to claim 1 in which there is a plurality of the side facing seats, with at least a first one of the seats facing a first side of the vehicle and at least a second one of the seats facing a second side of the vehicle, and in which there are two of the protection bars, with a first one of the protection bars being for the first one of the seats facing the first side of the vehicle, and with a second one of the protection bars being for the second one of the seats facing the second side of the vehicle.

3. Seating apparatus according to claim 2 in which the plurality of seats are arranged in two rows with the first row facing the first side of the vehicle and the second row facing the second side of the vehicle.

4. Seating apparatus according to claim 1 in which the or each protection bar is integrally formed with the remainder of the frame.

5. Seating apparatus according to claim 1 in which the or each protection bar makes an angle of 5-25° with the vertical plane.

6. Seating apparatus according to claim 5 in which the or each protection bar makes an angle of 20° with the vertical plane.

7. Seating apparatus according to claim 1 in which the or each protection bar is at a height which enables easy access to the seat for getting on and off the seat.

8. A vehicle when provided with seating apparatus according to claim 1.
